(19) United States
(12) Patent Application Publication
(10) Pub. No.: US 2011/0262313 A1
(43) Pub. Date: Oct. 27, 2011

(54) DEVICE FOR PRODUCING HYDROGEN BY MEANS OF AN ELECTRON CYCLOTRON RESONANCE PLASMA

(75) Inventors: Denis Hitz, Grenoble (FR); Marc-Yves Delaunay, Meylan (FR)

(73) Assignee: Commissariat Á L'Énergie Atomique Et Aux Énergies Alternatives, Paris (FR)

(21) Appl. No.: 13/121,524

(22) PCT Filed: Sep. 29, 2009
(86) PCT No.: PCT/FR09/51841

§ 371 Date: Jul. 15, 2011

(30) Foreign Application Priority Data
Sep. 30, 2008 (FR) 0856613

(51) Int. Cl. B01J 19/12

(52) U.S. Cl. 422/186.01

(57) ABSTRACT

A device includes a chamber to contain plasma, a water vapor injector to inject water vapor into the chamber, a high-frequency wave injector to inject a high-frequency wave inside the chamber, a magnetic structure to generate a magnetic field in the chamber and to generate plasma along the magnetic field lines, a module of the magnetic field presenting a magnetic mirror configuration with at least one electron cyclotron resonance zone to at least partially dissociate the water molecules introduced in vapor phase and to at least partially ionize the products of dissociation. The magnetic mirror configuration is such that the module of the magnetic field presents a nonpoint-shaped minimum, substantially constant, and substantially equal to the magnetic field corresponding to electron cyclotron resonance and at least partially extending along the chamber, such that the plasma has the form of a plasma surface; the water vapor injector injecting the vapor in the form of a supersonic jet and including a planar nozzle and a divertor. The device also includes a selective cryogenic condenser to freeze the oxygen coming from the dissociation without freezing the hydrogen coming from the dissociation and a hydrogen recovery unit configured to recover the hydrogen coming from the dissociation, the oxygen being trapped by the cryogenic condenser.

The present invention relates to a device for producing hydrogen from electron cyclotron resonance plasma.

Today hydrogen (H₂) appears to be an energy vector of great interest, which is called to take on more and more importance and which may, eventually, advantageously be substituted for petroleum and fossil fuels, whose reserves will significantly decrease in the decades to come. In this perspective, it is necessary to develop effective methods to produce hydrogen.

Admittedly, many methods for producing hydrogen from various sources have been described, but a number of these methods have turned out to be unsuitable with regard to the limitation of greenhouse gases.

A first technique consists of using water vapor reforming. This is a technique for transforming light hydrocarbons such as methane into synthesis gas by reaction with water vapor on a catalyst. The two main chemical reactions of this method are the production of synthesis gas and the conversion of CO:

CH₄+H₂O→CO+3H₂

CO+H₂O→CO₂+H₂

the overall result being

CH₄+2H₂O→CO₂+4H₂

One of the main problems with this synthesis route is that it produces, as by-products, significant quantities of CO2-type greenhouse gases.

A second method consists of using a partial oxidation technique: This is an exothermal technique, generally without oxidation catalyst, for products such as natural gas, heavy oil residues and coal. The production of synthesis gas is given by the reaction:

CₙHₘ+(n/2)O₂→nCO+(m/2)H₂

The conversion of carbon monoxide is given by the reaction:

nCO+nH₂O→nCO₂+nH₂

As with reforming, this technique produces a significant quantity of carbon dioxide.

Mention may also be made of a third technique using the direct thermal decomposition of water; such a technique would necessitate extremely high temperatures on the order of 3000 to 4000 K (the use of a catalyst enables this temperature to be reduced, which would, however, remain very high, approaching 1400 K). This production technique is considered by utilizing high-temperature nuclear reactors cooled by a gaseous coolant such as helium (the case of HTR “High Temperature Reactor” type, fourth generation reactors). By virtue of its principle, this technique is connected to uranium production. The other disadvantage is that using this method for producing small amounts of hydrogen is unthinkable.

A fourth pathway consists of carrying out water electrolysis: this is a technique of dissociating water by the passage of an electric current according to the reaction:

$${H}_{2} O \to {H}_{2} + \frac{1}{2} {O}_{2}$$

This reaction, in which the enthalpy is ΔH=285 kJ.mol-1 (at 298K and 1 bar) is carried out according to the following method: An electrolyte cell is constituted of two electrodes, an anode and a cathode, connected to a direct current generator. The electrodes are immersed in an electrolyte used as a electrical conductor. In general, this electrolyte is an acid or basic aqueous solution, a polymeric proton exchange membrane (H⁺) or an oxygen ion conductive membrane (O²⁻).

However, this technique poses certain difficulties; thus the electrodes corrode over time. In addition, such a method necessitates the ongoing adjustment of concentrations and the use of membranes that are either fragile for organic membranes, or have a low yield for mineral membranes.

A fifth solution consists of water decomposition by thermochemical cycle (TCC): This method uses a series of chemical reactions. One example is the use of the iodine-sulfur cycle based on the decomposition of two acids at high temperature: sulfuric acid produces oxygen and sulfur dioxide, and hydroiodic acid produces hydrogen and iodine.

The disadvantage of this technique is the implementation of rather complex chemical reactions producing, in addition to hydrogen, many other elements, such as sulfur in the case of the iodine-sulfur cycle or Fe₃0₄ and HBr in the case of the UT-3 cycle.

A sixth pathway considered is the biomass: Obtained by the photosynthesis of carbon dioxide and water, it uses solar energy to produce C₆H₉O₄ molecules. Then there is a thermochemical treatment according to the reaction:

C₆H₉O₄+2H₂O+880kJ→6CO+13/2H₂

Gasification to water vapor around 900° C. then produces synthesis gas (CO+H₂O). A hydrogen supplement is then obtained by the “gas shift” reaction.

6CO+6H₂O→6CO₂+6H₂

Again, the main disadvantage of this technique resides in its production of carbon dioxide.

A seventh technique consists of carrying out photoelectrolysis of water: This is a process that uses the dissociation of the water molecule by an electric current produced by illuminating a semiconductor photocatalyst (Ti0₂, AsGa).

This process does not produce greenhouse gas but has a relatively low conversion efficiency.

Another method to produce hydrogen gas by microwave plasma is proposed in document WO2006/123883. This method uses the dissociation of gaseous molecules by electron impact. The method disclosed consists of injecting microwave frequencies into a dielectric tube containing an H₂0 or CH₄ type gas or vapor under reduced pressure, on the order of 50-300 torr. This microwave power causes the ionization and/or dissociation of gas by thus releasing hydrogen (initiating microwave plasma). At the end of the tube, a separator, type palladium, separates the hydrogen by gaseous diffusion.

Another method to produce hydrogen from water molecules is described in document WO2005/005009. The method disclosed consists of placing water molecules in an electromagnetic field to excite the molecules by thermal agitation until their excitation energy exceeds the bond energy of the H and O atoms composing the water molecule.

Another method of producing hydrogen by injecting water vapor in plasma is described in document US2004/0265137. This patent describes a method of obtaining hydrogen from vapor dissociated in plasma. The document notably mentions the use of electron cyclotron resonance (ECR) to produce said plasma. With relation to the hydrogen production methods previously cited, the use of an ECR plasma machine presents many advantages:
continuous and stable operation;
no implementation of high temperatures;
no wear (very long operating time due to the absence of filament or electrodes);
no production of carbon or carbon compounds;
no utilization of chemical complexes;
low cost, if the magnetic structure is made of permanent magnets.

However, despite the advantages mentioned above, a major problem with a plasma machine that breaks, by electron impact, water molecule bonds is the separation of the products formed.

Inserting a dielectric is a possible solution. However, this method presents the disadvantage of using rare and costly compounds.

In this context, the object of the present invention is to provide a device for producing hydrogen from water with electron cyclotron resonance plasma not necessarily requiring significant magnetic fields and enabling effective dissociation of the water molecules and simple separation of the products formed.

For this purpose, the invention proposes a device for producing hydrogen with electron cyclotron resonance plasma comprising:
a sealed vacuum chamber intended to contain plasma,
means for injecting water vapor into said chamber,
means for injecting a high-frequency wave inside said chamber,
a magnetic structure for generating a magnetic field in said chamber and generating plasma along the magnetic field lines, the module of said magnetic field presenting a magnetic mirror configuration with at least one electron cyclotron resonance zone to at least partially dissociate the water molecules introduced in vapor phase and to at least partially ionize the products of dissociation,
   said device being characterized in that said magnetic mirror configuration is such that the module of said magnetic field presents a nonpoint-shaped minimum, substantially constant and substantially equal to the magnetic field corresponding to the electron cyclotron resonance, at least partially extending along said chamber, such that said plasma has the form of a plasma surface;
   said water vapor injection means injecting said vapor in the form of a supersonic jet, said injection means comprising a planar nozzle and a divertor, said divertor being intended to shape said vapor jet such that it is directed along the axis of said chamber;
   said device comprising:
at least one selective cryogenic condenser to freeze the oxygen coming from the dissociation without freezing the hydrogen coming from the dissociation, said at least one selective cryogenic condenser freezing the oxygen along said plasma surface generated in said chamber;
means for recovering the hydrogen coming from the dissociation, the oxygen being trapped by said at least one cryogenic condenser.

Sealed vacuum chamber is understood to refer to a chamber in which a working pressure of less than or equal to 5.10⁻³ mbar exists, said working pressure substantially corresponding to the partial pressure of water vapor injected into the chamber.

Magnetic field substantially equal to the magnetic field corresponding to the electron cyclotron resonance is understood to refer to a magnetic field equal to about ±10% of the magnetic field corresponding to the electron cyclotron resonance.

Magnetic field substantially constant to the magnetic resonance field is understood to refer to a magnetic field not deviating by more than 10% from the magnetic resonance field.

Thanks to the invention, effective production of hydrogen from water vapor is obtained. The device according to the invention is based on the combined use of electron cyclotron resonance plasma and at least one selective cryogenic condenser. This non-C0₂ emitting device does not use electrodes, ohmic heating, membranes or high temperatures.

Thanks to the principle of electron cyclotron resonance plasma, at every passage near the resonance zone, the electrons will acquire energy. They will then be able to dissociate the water molecules and then ionize the products of dissociation. Thanks to the electroneutrality of plasma, these ions will follow the electrons along the magnetic field lines.

According to the invention, the mirror configuration of the magnetic field forms a profile of the magnetic field comprising a nonpoint-shaped minimum, called a “flat field” minimum, in which the value of the module of the magnetic field is equal to the value of the magnetic resonance field at about ±10%. This value of the magnetic field minimum module, equal to or very close to the electron cyclotron resonance, at least partially extends along the sealed chamber of the device, typically over a length greater than 10 cm, between the two maxima of the magnetic field, thus allowing an extensive surface of hot plasma to be obtained. The value of the module inside the chamber is constant over the entire height of said chamber for a given z on the axis of the chamber. In this way, the electrons will acquire a large quantity of energy in order to effectively dissociate the water molecules and ionize the dissociation products. In addition, the oxygen coming from the dissociation of water molecules will be effectively trapped along the entire sealed chamber and over a great length.

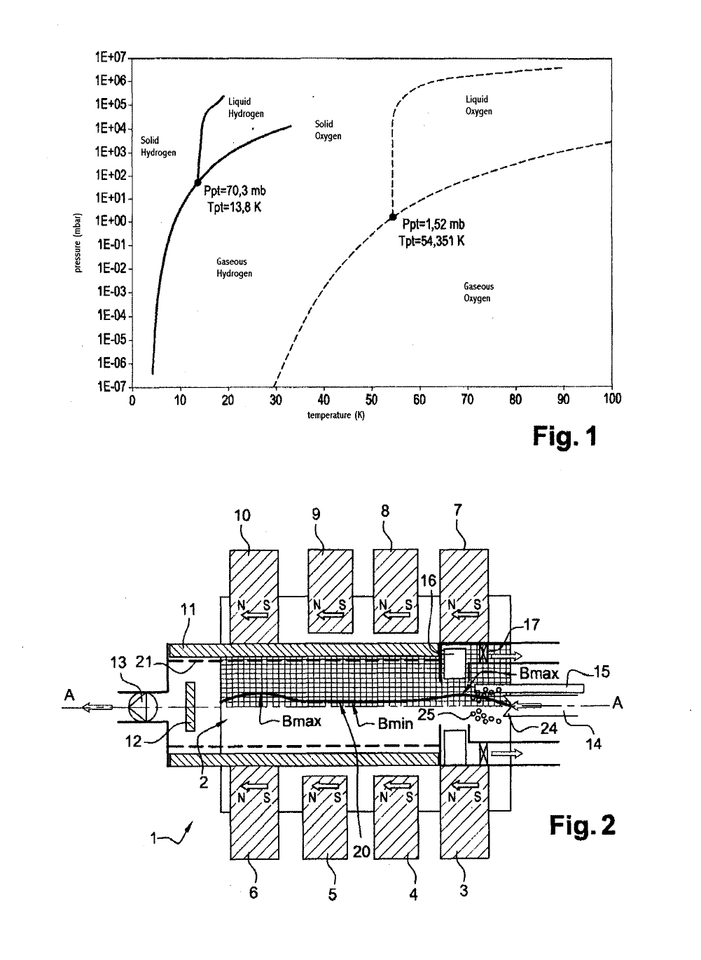

By observing the phase diagrams of the hydrogen and oxygen elements for the low temperatures represented in FIG. 1, the operating pressure of the plasma machine under consideration being less than 5.10⁻³ mbar, it is noted that for a temperature of between 5K and 35K, the oxygen is cryocondensed while the hydrogen remains in gaseous form. Thus, by using one or more cryogenic condensers forming the wall of the plasma chamber, cooled to a temperature such that the two elements, hydrogen and oxygen, composing the plasma are in different phases (gaseous hydrogen and solid oxygen), the oxygen may be trapped in solid form without trapping the hydrogen, that will be recovered by other means. The temperature of the condenser depends on the partial hydrogen pressures from the initial density of the plasma that is itself a function of the microwave frequency injected. The oxygen being trapped, means to recover the hydrogen are then used, such as a conventional pumping system (a turbomolecular pump, for example) to pump the hydrogen. It is also possible to advantageously use the fact that the ionized particles follow, by plasma electroneutrality, the electrons that are guided by the magnetic field lines.

In fact, if the oxygen cryocondensation device is placed in the magnetic field lines, hydrogen cryocondensation devices may then advantageously be placed outside the magnetic field lines.

It will be noted that, although an electromagnetic field is used, the device according to the invention does not use the water molecule thermal agitation method, but on the other hand breaks the atomic bonds by collisions with plasma electrons.

According to a particularly advantageous method of the invention, said chamber comprises water vapor injection means, injecting the water vapor along the longitudinal axis AA′ of the chamber directly into the hot plasma.

The device according to the invention may also present one or more of the characteristics below, considered individually or according to all technically possible combinations:
said at least one selective cryogenic condenser for freezing the oxygen forms the inside wall of said chamber;
said at least one selective cryogenic condenser for freezing the oxygen is situated in the region of said magnetic field nonpoint-shaped minimum;
said at least one selective cryogenic condenser for freezing the oxygen is a condenser in annular form surrounding said plasma present in said chamber;
said at least one selective cryogenic condenser for freezing the oxygen coming from the dissociation without freezing the hydrogen coming from the dissociation is at a temperature of between 6 and 40K for an average pressure substantially equal to 5.10⁻³ mbar in said chamber;
said device comprises a plurality of selective cryogenic condensers to freeze the oxygen in annular form surrounding said plasma;
said device comprises a second cryogenic condenser to freeze the oxygen coming from the dissociation placed at the end of said chamber between said magnetic mirror configuration and said hydrogen recovery means;
said magnetic structure comprises a plurality of permanent magnets;
said plurality of permanent magnets has the same magnetization direction;
said magnetic structure comprises permanent magnets whose poles face each other in the water vapor injection zone;
said magnetic structure comprises permanent magnets whose poles face each other in the hydrogen recovery zone;
said permanent magnets located in the water vapor injection zone have a different polarity from said permanent magnets located in the hydrogen recovery zone;
said magnetic structure comprises permanent magnets of different sizes and presenting either a same magnetization or different magnetizations;
said magnetic structure comprises coils at ambient temperature and/or superconducting coils at low or high critical temperature, called low or high Tc;
said device comprises means for recovering non-dissociated water, said non-dissociated water recovery means being substantially arranged along the vapor injection axis (AA′);
said non-dissociated water recovery means form a diaphragm around said water vapor injection means, so as to define the shape of the water vapor jet;
said non-dissociated water recovery means are formed by a cryogenic condenser;
said device comprises at least one system for reinjecting non-dissociated water in vapor phase and coming from said non-dissociated water recovery means;
said device comprises a screen presenting a mesh allowing the propagation of high-frequency waves to be stopped;
said screen is inserted between the plasma of the chamber and said at least one selective cryogenic condenser for freezing the oxygen coming from the dissociation so as to protect said at least one cryogenic condenser from high-frequency waves;
said screen is formed by a metal mobile cylinder comprising solid parts and pierced parts for the at least partial protection of said at least one cryogenic condenser from high-frequency waves;
said device comprises an enclosure able to recover oxygen when the temperature of said at least one cryogenic condenser for freezing the oxygen is high;
said means to recover the hydrogen coming from the dissociation are placed outside of said magnetic mirror configuration;
said means for recovering hydrogen coming from the dissociation comprise a pump used to pump hydrogen in gaseous phase;
said means to recover the hydrogen coming from the dissociation comprise at least one cryogenic condenser for freezing the hydrogen;
said device comprises an enclosure able to recover hydrogen when the temperature of said at least one cryogenic condenser for freezing the hydrogen is high;
said means for injecting a high-frequency wave inside said chamber comprise an entrance window placed in a high magnetic field so that the plasma diffuses towards the chamber and thus avoids the plasma impact on said window;
said module of said magnetic field minimum is between 90% of said electron cyclotron resonance value and said electron cyclotron resonance value;
said device comprises means for injecting high-frequency multi-frequency waves.

Other characteristics and advantages of the invention will clearly emerge from the description given below, for indicative and in no way limiting purposes, with reference to the attached figures, among which:

FIG. 1 is a representation of the hydrogen and oxygen phase diagrams with values corresponding to the triple point of each element;

FIG. 2 represents in top view a first embodiment of the device according to the invention;

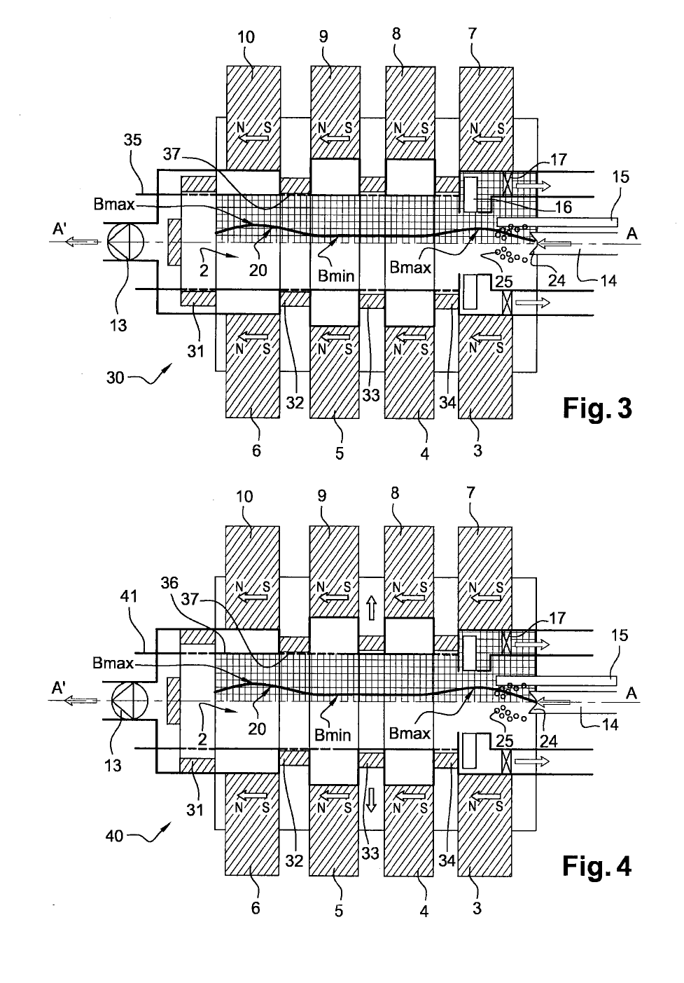

FIG. 3 represents in top view a second embodiment of the device according to the invention;

FIG. 4 represents in top view a third embodiment of the device according to the invention;

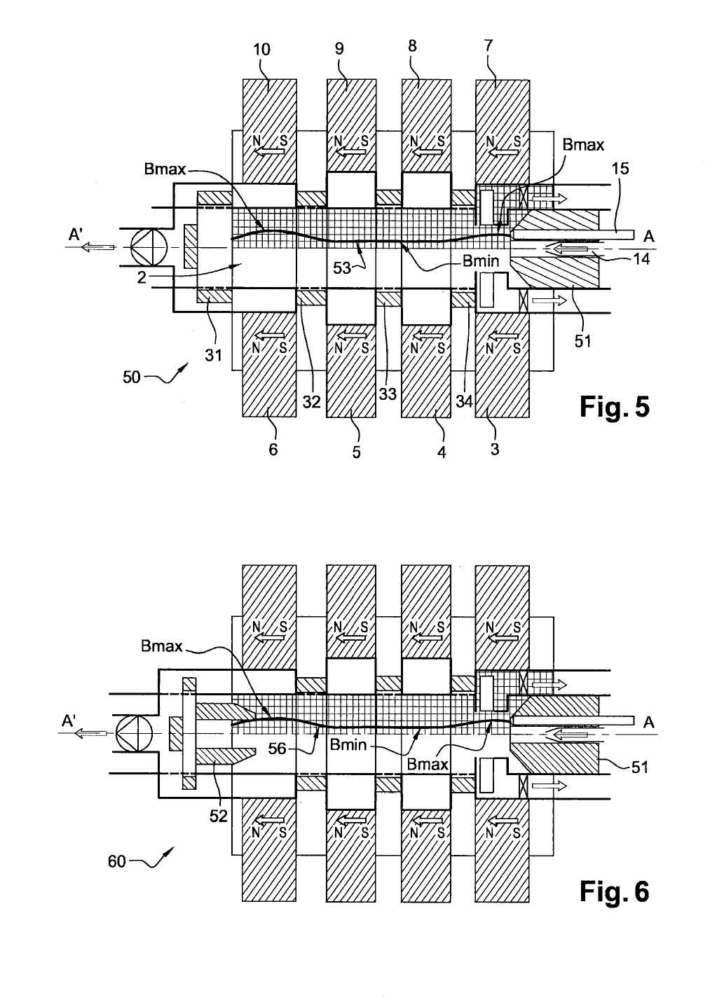

FIG. 5 represents in top view a fourth embodiment of the device according to the invention;

FIG. 6 represents in top view a fifth embodiment of the device according to the invention;

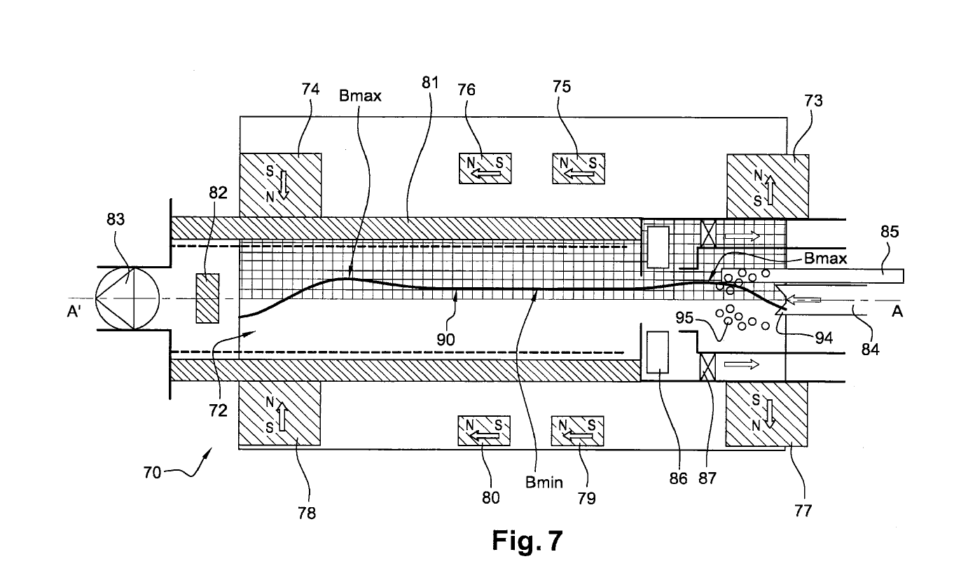

FIG. 7 represents in top view a sixth embodiment of the device according to the invention.

In all figures, common elements bear the same reference numbers.

FIG. 1 has already been described previously in reference to the general presentation of the invention.

FIG. 2 is a simplified representation of a device 1 for producing hydrogen by electron cyclotron resonance plasma according to a first embodiment of the invention.

The device 1 comprises:
a sealed vacuum chamber 2 in parallelepiped form (also called enclosure subsequently);
eight permanent bar magnets 3, 4, 5, 6, 7, 8, 9, 10 placed outside chamber 2 (the bars typically have a height of between some centimeters and 1 m, or even more if need be);
a first cryogenic condenser 11 to trap the oxygen forming the lateral wall of the sealed chamber 2;
a second cryogenic condenser 12 to trap the oxygen located perpendicular to axis AA′ of chamber 2;
a pump 13 enabling the recovery of the hydrogen in gaseous form;
means for injecting water vapor 14 into chamber 2 composed of an enclosure where the water vapor exists, said enclosure being connected to the sealed chamber 2 by a nozzle 24 so as to create a supersonic jet of water vapor. The water vapor jet is shaped with divertors 25 constituted of pipes in which a fluid, whose temperature is close to 5° C., flows. The water vapor that comes in contact with the divertors 25 is immediately condensed and flows along divertors 25. The vapor jet 15 is thus limited in radial dimension and is oriented along the longitudinal axis AA′ of chamber 2;
means to propagate high-frequency waves 15, of the low frequency microwave type, less than or substantially equal to 2.45 GHz, formed by a waveguide or coaxial cable equipped with a sealed high-frequency window inside chamber 2;
a cryogenic condenser 16 to trap the non-dissociated water vapor so as to have high directivity of the vapor jet;
a pump 17 for recycling non-dissociated water in vapor or liquid phase.

Chamber 2 is put under vacuum, the vacuum being achieved by pumping means. In order to have the fewest impurities in chamber 2, a residual vacuum of 10⁻⁴ mbar minimum is necessary. During operation of device 1, the working pressure of chamber 2 is typically less than or equal to 5.10⁻³ mbar, this pressure being connected to the partial pressure of water vapor injected into chamber 2.

The magnetic structure, formed by the eight permanent bar magnets 3, 4, 5, 6, 7, 8, 9, 10 surrounding chamber 2, produces inside chamber 2 an axial magnetic field in which the configuration of the module corresponds to a magnetic mirror type configuration in which profile 5 presents at least two maxima (Bₘₐₓ) at abscissae located respectively in the injection and extraction zones and one nonpoint-shaped minimum (Bₘᵢₙ) at least partially extending along chamber 2 and located between the two maxima (Bₘₐₓ). The two maxima (Bₘₐₓ) have a value greater than the value of the magnetic field (Bᵣₑₛ) for which the electron cyclotron resonance is obtained. The minimum (Bₘᵢₙ) is a minimum known as flat field, whose value is equal to or slightly less than the value for which the electron cyclotron resonance is obtained over a long abscissa length.

The magnetic mirror configuration is a configuration known as minimum-B: The plasma electrons are confined in magnetic well. The longer the length of the minimum-B less than or equal to the resonance field, the more the plasma will comprise fast electrons, leading to a better dissociation of water vapor into oxygen and hydrogen.

Thanks to the principle of electron cyclotron resonance, at every passage in the resonance zone, the electrons will acquire energy. They will then be able to dissociate the water molecules and then partially ionize the products of dissociation. The electrons follow the magnetic field lines thanks to Laplace's law; And, thanks to the electroneutrality of plasma, these ions will follow the electrons along the magnetic field lines.

Microwaves injected into the plasma tend to propagate through the plasma up to the resonance zone. In fact, the energy transfer of the injected microwave power to the plasma electrons is produced at a magnetic field location (Bᵣₑₛ) such that the electron cyclotron resonance condition is established, i.e., when there is equality between the high frequency wave HFW pulse and the cyclotron pulse of the electron:

ti ω_{HF}=ω_{ce}=qₑBᵣₑₛ/mₑ
where qₑ is the electron charge (Cb); Bᵣₑₛ is the magnetic field corresponding to the resonance (T);
mₑ is the electron mass.

A microwave generator, not represented, is placed outside chamber 2; this generator injects high-frequency waves inside chamber 2 via propagation means 15. The microwave frequency range may go from the GHz to a hundred GHz, the most common generator being the magnetron at 2.45 GHz commonly used for domestic microwave ovens. For a frequency of 2.45 GHz, there is a magnetic field resonance Bᵣₑₛ=0.0875 T. However, for miniature hydrogen production devices (for embedded systems, for example), power transistors may also be used. In fact, field effect transistors capable of delivering approximately 60 W at 14.5 GHz now exist.

Advantageously, the high-frequency wave entrance window is placed in a strong magnetic field zone, in the region, for example, of the first maxima (Bₘₐₓ) of profile 20 of the axial magnetic field module, such that the plasma diffuses in the direction of plasma chamber 2 and not towards the entrance window, so as to avoid any bombardment of this window by the plasma, thus guaranteeing an unlimited lifetime. Using “overdense” plasmas, where the plasma frequency is greater than the microwave frequency, is also possible. The use of “overdense” plasmas enables the electronic density to be advantageously increased and thus the system efficiency to be increased.

The means 14 for injecting water vapor into chamber 2 are preferentially placed near the microwave propagation means (however, another location may also be chosen for reasons of convenience). Water is introduced in plasma chamber 2 in the form of a supersonic jet of vapor with the intention of obtaining high directivity of the water vapor in order to direct the water vapor directly in the hot plasma towards the resonance zone of chamber 2. This jet comes from a nozzle 24, itself used as an opening to an enclosure where the water vapor is located. divertors 25 are placed at the output of nozzle 24 so as to define the angular opening of the jet. These divertors 25 are constituted of pipes in which a liquid whose temperature is close to 5° C. (a lower temperature would lead to solidification of the water on the divertors) circulates. The water vapor that comes in contact with the divertors is immediately condensed and flows along divertors 25.

In order to further improve this directivity by the size reduction of the vapor jet, a cryogenic condenser 16, formed for example by a cryogenic ring, is placed in the region of the first maxima (Bₘₐₓ) of the magnetic field, whose profile 20 represents the magnetic field module along chamber 2. The cryogenic condenser 16, whose temperature is close to 200 K, is used as a diaphragm with the intention of trapping by cryocondensation the water vapor located in the external part of the vapor jet. Condenser 16 also prevents the saturation in non-dissociated water of main cryogenic condensers 11 and 12 necessary for the dissociation of ionized elements. When cryogenic condenser 16 is water saturated, a device, not represented, enables condenser 16 to be insulated with the intention of regenerating the condenser. To do this, the device heats the cold walls of the condenser in order to recover, from the cold walls, the water in liquid or gaseous form to be reinjected in device 1 by recycling pump 17.

The cryogenic condenser 16 may be replaced by a liquid condenser comprising vertical tubing in which a pressure gradient (from 10⁻³ mbar to 10² mbar or 1 bar) is established. Thus, the water, that passes from vapor form to liquid form, flows along the vertical tubing by gravity and is advantageously recycled via recycling pump 17. However, if the recycling tubing is short, the pressure gradient in the tubing may remain low and the water may be reinjected into device 1 directly in vapor phase.

The magnetic structure is formed by permanent magnets 3, 4, 5, 6, 7, 8, 9 and 10 in bar form having the same magnetization direction for all the magnets. The orientation of permanent magnets 3, 4, 5, 6, 7, 8, 9 and 10 is such that the magnetic profile 20 has a magnetic mirror configuration formed by a nonpoint-shaped minimum-B, known as “flat field minimum” extending over a large part of the length of the device along the AA′ axis and situated between two maximum values (Bₘₐₓ) of the magnetic field. The maximum values of the field are rather high, on the order from 0.15 T to 0.3 T, so as to limit axial leaks of plasma; the maximum values may also reach several tesla.

The minimum-B value is a value equal to or less than the value of the magnetic resonance field (Bᵣₑₛ) on the order of 90% Bᵣₑₛ, i.e., approximately 0.08T. This magnetic field value equal to or slightly less than the electron cyclotron resonance is extended over a large part of the length of the device, on the order of 25 cm. Thus, the electrons may acquire a large quantity of energy in order to effectively dissociate the water molecules over the entire length of device 1.

Using a multi-frequency microwave injection source in which the combination of bandwidths of each frequency forms a large frequency band leading to the formation of a large resonance zone is also possible; the width of the resonance zone substantially corresponding to the bandwidth of the microwave source.

Thanks to the flat minimum-B magnetic configuration, the plasma has the form of a long column extending over a large part of the chamber, with a significant density in output of the vapor jet and a pressure gradient along chamber 2. Device 1 does not provide radial confinement of the plasma by virtue of the radial inhomogeneity of the magnetic field. In this case, the ionized particles forming the plasma tend to undergo radial drift, according to a phenomenon known in plasma physics.

Cryogenic condensers 11 and 12 are cold-wall condensers, called cryopanels or cryogenic panels. Condenser 11 is advantageously placed on the inner surface of chamber 2 so as to condense the desired ionized particles. The cold walls of condenser 11 have a temperature close to, for example, 20-30K so as to condense all the elements present in chamber 2, except the hydrogen which remains in gaseous form at this temperature under the working pressure of 0.1 Pa.

In fact, according to the phase diagrams from FIG. 1, at the operating pressure of enclosure 2, i.e., at least 5.10⁻³ mbar, at a temperature between 6K and 40K (preferentially between 5K and 30K), it is possible to cryocondense the oxygen while keeping the hydrogen in gaseous form.

It will be noted that the various components coming from the dissociation of water are essentially: H₂, 0₂, OH, H, O, 0⁺, H⁺, H₂⁺, 0₂⁺, OH⁻. All the ionized elements cancel each other out before touching a wall (either a cold wall of a cryopanel or another wall), while the neutral elements recombine to give stable elements: H₂, 0₂, H₂0.

The cryogenic condenser 12 is advantageously placed in the axis of the vapor jet 14 outside of the plasma before a hydrogen pumping system, so as to condense the ionized oxygen particles as well as the non-dissociated water vapor. As the oxygen coming from the water dissociation is trapped on the entire length of device 1, the hydrogen only has to be pumped axially to the other end of device 1 and then sent to a compressor (not represented).

A high-frequency (HF) screen 21 is placed before cryopanels 11 so as to protect the cryopanels and prevent them from being heated by microwaves, the mesh of the HF screen (21) being determined according to the microwave wavelength.

It will be noted that, according to the grid represented in FIG. 2, one square on the abscissa substantially corresponds to 1 cm. The dimensions of each magnet have been calculated so as to obtain, in the plasma chamber, a long resonance zone, where the electrons take on enough energy to dissociate the water molecules and at least partially ionize the products of dissociation.

The best water dissociation rates being obtained for pressures of less than 5.10⁻³ mbar, this value is considered to be a maximum pressure in enclosure 2, all the more so as the electrons would not be magnetically guided if this pressure is increased beyond 5.10⁻³ mbar.

FIG. 3 is a variation of the previous figure (the means in common between devices 1 and 30 bear the same reference numbers and carry out the same functions). Device 30 according to this second embodiment is differentiated from device 1 of FIG. 2 in that it comprises a plurality of cryopanel or cryogenic panel type cold wall cryogenic condensers 31, 32, 33, 34 placed inside chamber 2. Typically according to this embodiment, each cryogenic condenser 31, 32, 33, 34 among the four represented is placed between a succession of magnets.

A metal cylinder 35, that is mobile along the AA′ axis, is inserted between condensers 31, 32, 33, 34 and the plasma. Metal cylinder 35 is used as a protection screen for condensers 31, 32, 33, 34. Cylinder 35 comprises solid parts and parts 37 pierced by a mesh, said mesh corresponding to the wavelength of the microwaves utilized.

When all the pierced parts are placed before condensers 31, 32, 33, 34, the oxygen dissociated by the plasma is trapped by the cold walls of condensers 31, 32, 33, 34. The cold walls of condensers 31, 32, 33, 34 have a temperature close to, for example, 20-30K so as to condense all the elements present in chamber 2 except for the hydrogen, that remains in gaseous form. In a second position of this mobile cylinder 35, the solid parts are placed before the cold walls of condensers 31, 32, 33, 34. In this position, the device is stopped, enabling oxygen to be recovered by regeneration of cold walls of condensers 31, 32, 33, 34 by heating the walls.

FIG. 4 is a variation of the previous figure (the means in common between devices 30 and 40 bear the same reference numbers and carry out the same functions). Device 40 according to this third embodiment is differentiated from device 30 of FIG. 3 in that it comprises a mobile metal cylinder 41 comprising a particular layout of solid parts 36 and pierced parts 37.

The arrangement of these solid parts 36 and pierced parts 37 is such that in a first position of cylinder 41, three cryogenic condensers, for example 31, 32 and 34 are in operation, i.e., they are trapping the hydrogen elements, and a cryogenic condenser, for example 33, is in a regeneration process. In this way, device 40 may operate without interruption. As soon as a condenser 31, 32, 33, or 34 wall is saturated, the mobile cylinder 41 only has to be displaced along different positions so as to conceal the oxygen-saturated wall from the plasma with the intention of regenerating it during operation of the device.

According to a particular embodiment of the invention, it is possible to have different condensers 31, 32, 33, 34 at different distances from the center of chamber 2 where the hot plasma is housed. For example, condenser 34 placed close to the vapor jet will be farther from the center of chamber 2 so as to protect it from projections of water from the vapor jet that would excessively freeze on the cold wall. Condenser 31 located close to the system for recovering hydrogen in gaseous form may be placed closer to the plasma or the center of chamber 2 so as to be able to pump the last oxygen atoms remaining in this zone.

FIG. 5 is a variation of the previous figure (the means in common between devices 40 and 50 bear the same reference numbers and carry out the same functions). Device 50 according to this fourth embodiment is differentiated from device 40 of FIG. 4 in that it comprises a nozzle 51 in a ferromagnetic material enabling the effectiveness of the magnetic mirror situated in the microwave injection zone to be increased.

The additional part is a part substantially in elongated form in iron or ferro-cobalt, for example, including means for propagating high-frequency waves 15 and surrounding the water vapor jet 14.

In this way, the arrangement and material of nozzle 51 enable the first maxima (Bₘₐₓ) of profile 53 to be increased without modifying the minimum-B, remaining identical to the embodiments detailed previously, profile 53 representing the intensity of the axial magnetic field present in chamber 2.

In this way, the maximum value Bₘₐₓ of profile 53 may be three times greater than the maximum value Bₘₐₓ of profile 20 detailed in the previous embodiments of the invention illustrated with reference to FIGS. 2 to 4, which ensures better plasma confinement.

The minimum-B value is equal to or slightly less than the value of the magnetic resonance field (Bᵣₑₛ) on the order of 90% Bᵣₑₛ, i.e., approximately 0.08T. This magnetic field value equal to or slightly less than the electron cyclotron resonance is extended over a large part of the length of the device, on the order of 25 cm.

FIG. 6 is a variation of the previous figure (the means in common between devices 50 and 60 bear the same reference numbers and carry out the same functions). Device 60 according to this fifth embodiment is differentiated from device 50 of FIG. 5 in that it comprises a second ferromagnetic nozzle 52 placed in the region of a second maxima Bₘₐₓ of profile 56.

Thus according to this fifth embodiment, profile 56 representing the intensity of the magnetic field presents two maxima whose intensity is higher than the maxima from the previous embodiments, thus ensuring better plasma confinement.

FIG. 7 is a simplified representation of a sixth embodiment of a device 70 for producing hydrogen by electron cyclotron resonance plasma.

The device 70 comprises:
a sealed vacuum chamber 72 in parallelepiped form (also called enclosure subsequently);
eight permanent bar magnets 73, 74, 75, 76, 77, 78, 79, 80 placed outside of chamber 72 (the bars typically have a height of between some centimeters and 1 m, or even more if necessary);
a first cryogenic condenser 81 to trap the oxygen forming the lateral wall of the sealed chamber 72;
a second cryogenic condenser 82 to trap the oxygen located perpendicular to the axis of chamber 72;
a pump 83 enabling the recovery of the hydrogen in gaseous form;
means for injecting water vapor 84 into chamber 72 composed of an enclosure where the water vapor exists, said enclosure being connected to the sealed chamber 72 by a nozzle 94 so as to create a supersonic jet of water vapor. The water vapor jet is shaped with divertors 95 constituted of pipes in which a fluid, whose temperature is close to 5° C., flows. The water vapor that comes in contact with the divertors 95 is immediately condensed and flows along divertors 95. The vapor jet is thus limited in radial dimension and is oriented along the longitudinal axis AA′ of chamber 72;
means for injecting high-frequency waves 85, of the microwave type, formed by a waveguide or a coaxial cable equipped with a sealed high-frequency window inside chamber 72;
a cryogenic condenser 86 to trap the non-dissociated water vapor so as to have high directivity of the vapor jet;
a pump 87 for recycling non-dissociated water in vapor or liquid phase.

Chamber 72 is put under vacuum, the vacuum being achieved by pumping means. In order to have the fewest impurities in chamber 2, a residual vacuum of 10⁻⁴ mbar minimum is necessary. During operation of device 70, the working pressure of chamber 72 is typically less than or equal to 5.10⁻³ mbar, this pressure being connected to the partial pressure of water vapor injected into chamber 2.

The magnetic structure is formed by eight permanent bar magnets 73, 74, 75, 76, 77, 78, 79, 80 surrounding chamber 2.

The bar magnets 75, 76, 79, 80 have the same magnetization direction along the longitudinal axis of chamber 72, corresponding to the magnetization direction of bars 3, 4, 5, 6, 7, 8, 9 and 10 such as represented in the previous figures.

Similarly to the description done previously, the magnetic profile 90 has a magnetic mirror type configuration formed by a nonpoint-shaped minimum B, known as “flat field minimum” extending at least partially along chamber 2 and situated between two maximum values (Bₘₐₓ) of the magnetic field. The maximum values of the field (Bₘₐₓ) are rather high, on the order from 0.15 T to 0.3 T, so as to limit axial leaks of plasma.

Bar magnets 73, 74, 77, 78 are placed at the ends of enclosure 2 and their magnetization direction is perpendicular to the magnetization direction of magnets 75, 76, 79, 80, the field lines created by these magnets 73, 77 and 74, 78 being in opposition. The placement of magnets with a magnetization direction perpendicular to the direction of longitudinal axis AA′ of the enclosure enables the size of magnets 75, 76, 79, 80 to be reduced, which enables a magnetic mirror configuration with a flat field minimum-B slightly less than or equal to the magnetic resonance field to be obtained.

In this way, the magnets located around chamber 2 occupy less space than the previous representations, which enables the placement of means to regenerate the cold walls of cryogenic condensers present inside chamber 2 to be simplified.

According to a variation of FIG. 6, magnets 75, 79 and magnets 76, 80 may have different sizes, thus modifying the magnetic profile. For example, magnets 76 and 80 may have a smaller size so as to provide an axial magnetic field with a minimum-B value, near the water vapor injection, close to the magnetic resonance field and a minimum-B value lower than the magnetic resonance field in the region of the chamber 2 zone close to the hydrogen extraction. This variation provides less energetic electrons in the region of a zone close to the hydrogen extraction with better confinement in order to be able to dissociate the water molecules still present in this zone. To do this, a more conventional confinement is carried out in this zone with a profile comprising a strong field gradient, by reducing the minimum-B and keeping the maxima (Bₘₐₓ) values constant.

The invention has been mainly described with means enabling the extraction of hydrogen in gaseous form located at the end of chamber 2 and pumping the hydrogen axially; However, it is also possible to equip the device according to the invention with means to extract hydrogen pumping the hydrogen from the chamber radially in the region of the end of the device chamber. In fact, in the case of the utilization of a simple magnetic mirror configuration such as represented in FIGS. 2 to 7, there may be a significant flow of particles in the axis of the machine, this particle flow being all the lower when Bₘₐₓ is high. Radial pumping of the hydrogen enables 100% pure hydrogen to be obtained.

The invention has mainly been described, in the embodiments illustrated with reference to FIGS. 2 to 7, with hydrogen extraction in the region of the end of the chamber carried out by aspiration of hydrogen in gaseous form by means of a pump. It is also possible according to the invention to introduce, in chamber 2 in the region of the hydrogen extraction zone and outside the magnetic field lines, cold wall cryogenic condensers to trap the hydrogen, such as solid or openwork cryopanels whose wall temperature is less than 5K. Thus, the hydrogen and oxygen set on the independent cold walls such that one or the other only has to be heated independently to recover the hydrogen and oxygen separately, either in liquid form or in gaseous form.

The invention has mainly been described with a magnetic configuration comprising a minimum-B equal to or less than the value corresponding to the magnetic resonance field in which the minimum-B value is a constant value over a certain length of the device chamber corresponding to the distance between the two maxima (Bₘₐₓ); However, in another representation of the invention, the minimum-B of the magnetic configuration may be around a minimum value, while remaining very close to this minimum value over a long distance of the device chamber corresponding to the distance between the two maxima Bₘₐₓ.

The invention has mainly been described with a parallelepiped chamber surrounded by a magnetic structure formed by bar magnets and comprising cryogenic condensers in plate form; However, the invention is also attainable with a cylindrical sealed plasma chamber surrounded by a magnetic structure formed by circular magnets and comprising cryogenic condensers in ring form placed over the length of the plasma chamber.

The invention has mainly been described with a parallelepiped chamber surrounded by a magnetic structure formed of bar magnets; However, a part of the magnetic structure surrounding the plasma chamber such as, for example, the upper bar magnets may also be used as lower bar magnets for a magnetic structure surrounding a second sealed plasma chamber.

Lastly, the invention has mainly been described with an axial magnetic field, however, it is also possible to add a radial component to the axial magnetic field, for the dissociation for example of other elements necessitating the use of a radial magnetic field and/or to prevent radial leaks of plasma due to particle drift and to thus ensure better plasma confinement.

Of course, the invention is not limited to the embodiment that has just been described.

Thus, if one wishes to process a greater quantity of water, it is possible to increase the dimensions of the equipment while ensuring resonance zones in the plasma chamber. Thus, the length of the minimum-B equal to or slightly less than the resonance may be increased as needed up to several meters. It will be noted that the longer the plate of the minimum-B, the more effective the device according to the invention.

In addition, it is possible to use magnetic field coils (superconducting or not) to create more intense fields.

Even if the invention was more particularly described for low-frequency microwave frequencies on the order of 2.45 GHz, one may of course use higher microwave frequencies, as well as two injections of microwaves with similar frequencies so as to obtain a minimum-B value of between the two resonance values, as well as several injections of microwaves in which the bandwidth of each (some MHz) leads to a very wide frequency bandwidth and thus to a larger resonance zone.

1. A device (1, 70) for producing hydrogen by electron cyclotron resonance comprising:
a sealed vacuum chamber (2, 72) intended to contain plasma,
means for injecting water vapor (14, 84) into said chamber (2, 72),
means for injecting (15, 85) a high-frequency wave inside said chamber (2, 72),
a magnetic structure (3, 4, 5, 6, 7, 8, 9, 10, 73, 74, 75, 76, 77, 78, 79, 80) to generate a magnetic field in said chamber (2, 72) and to generate plasma along the magnetic field lines, the module of said magnetic field presenting a magnetic mirror configuration with at least one electron cyclotron resonance zone to at least partially dissociate the water molecules introduced in vapor phase and to at least partially ionize the products of dissociation,
said device being characterized in that said magnetic mirror configuration is such that the module of said magnetic field presents a nonpoint-shaped minimum, substantially constant, and substantially equal to the magnetic field corresponding to electron cyclotron resonance and at least partially extending along said chamber (2, 72), such that said plasma has the form of a plasma surface; said water vapor injection means (14, 84) injecting said vapor in the form of a supersonic jet, said injection means (14, 84) comprising a planar nozzle (24, 94) and a divertor (25, 95), said divertor (25, 95) being intended to shape said vapor jet such that it is directed along the axis (AA′) of said chamber (2, 72);
said device (1, 70) comprising:
at least one selective cryogenic condenser (11, 31, 32, 33, 34, 81) to freeze the oxygen coming from the dissociation without freezing the hydrogen coming from the dissociation, said at least one selective cryogenic condenser (11, 31, 32, 33, 34, 81) freezing the oxygen along said surface of plasma generated in said chamber (2, 72);
means for recovering (13, 83) the hydrogen coming from the dissociation, the oxygen being trapped by said at least one cryogenic condenser (11, 31, 32, 33, 81).

2. The device (1, 70) according to claim 1 characterized in that said at least one selective cryogenic condenser (11, 31, 32, 33, 34, 81) to freeze the oxygen forms the inner wall of said chamber (2, 72).

3. The device (1, 70) according to one of claims 1 to 2 characterized in that said at least one selective cryogenic condenser (11, 32, 33, 34, 81) to freeze the oxygen is located in the region of said magnetic field nonpoint-shaped minimum.

4. The device (1, 70) according to one of claims 1 to 3 characterized in that said at least one selective cryogenic condenser to freeze the oxygen is a condenser in annular form surrounding said plasma present in said chamber (2, 72).

5. The device (1, 70) according to one of claims 1 to 4 characterized in that said at least one selective cryogenic condenser (11, 31, 32, 33, 34, 81) to freeze the oxygen coming from the dissociation without freezing the hydrogen coming from the dissociation is at a temperature of between 6 and 40K for an average pressure substantially equal to 5.10⁻³ mbar in said chamber (2, 72).

6. The device (1, 70) according to one of claims 1 to 5 characterized in that it comprises a plurality of selective cryogenic condensers to freeze the oxygen in annular form surrounding said plasma.

7. The device (1, 70) according to one of claims 1 to 6 characterized in that it comprises a second cryogenic condenser (12, 82) to freeze the oxygen coming from the dissociation placed at the end of said chamber (2, 72) between said magnetic mirror configuration and said hydrogen recovery means (13, 83).

8. The device (1, 70) according to one of claims 1 to 7 characterized in that said magnetic structure (3, 4, 5, 6, 7, 8, 9, 10, 73, 74, 75, 76, 77, 78, 79, 80) comprises a plurality of permanent magnets.

9. The device (1, 70) according to claim 8 characterized in that said plurality of permanent magnets (3, 4, 5, 6, 7, 8, 9, 10, 75, 76, 79, 80) has the same magnetization direction.

10. The device (1, 70) according to one of claims 1 to 9 characterized in that said magnetic structure (73, 77) comprises permanent magnets whose poles face each other in the water vapor injection zone.

11. The device (1, 70) according to one of claims 1 to 10 characterized in that said magnetic structure (74, 78) comprises permanent magnets whose poles face each other in the hydrogen recovery zone.

12. The device (1, 70) according to claim 10 and claim 11 characterized in that said permanent magnets located in the water vapor injection zone have a different polarity from said permanent magnets located in the hydrogen recovery zone.

13. The device (1, 70) according to one of claims 1 to 12 characterized in that said magnetic structure (3, 4, 5, 6, 7, 8, 9, 10, 73, 74, 75, 76, 77, 78, 79, 80) comprises permanent magnets of different sizes and presenting either a same magnetization or different magnetizations.

14. The device (1, 70) according to one of claims 1 to 13 characterized in that said magnetic structure comprises coils at ambient temperature and/or superconducting coils at low or high critical temperature, called low or high Tc.

15. The device (1, 70) according to one of claims 1 to 14 characterized in that it comprises means (16, 86) to recover non-dissociated water, said non-dissociated water recovery means (16, 86) being substantially arranged along the vapor injection axis (AA′).

16. The device (1, 70) according to claim 15 characterized in that said non-dissociated water recovery means (16, 86) form a diaphragm around said water vapor injection means (14, 84), so as to define the form of the water vapor jet.

17. The device (1, 70) according to one of claims 15 to 16 characterized in that said non-dissociated water recovery means (16, 86) are formed by a cryogenic condenser.

18. The device (1, 70) according to one of claims 1 to 17 characterized in that the device comprises at least one system (17, 87) for reinjecting the non-dissociated water in vapor phase and coming from said non-dissociated water recovery means (16, 86).

19. The device (1, 70) according to one of claims 1 to 18 characterized in that it comprises a screen (21, 35) presenting a mesh enabling the propagation of high-frequency waves to be stopped.

20. The device (1, 70) according to claim 19 characterized in that said screen (21) is inserted between the plasma of the chamber (2) and said at least one selective cryogenic condenser (11, 31, 32, 33, 34, 81) to freeze the oxygen coming from the dissociation, so as to protect said at least one cryogenic condenser (11, 31, 32, 10 33, 34, 81) from high-frequency waves.

21. The device (1, 70) according to one of claims 19 to 20 characterized in that said screen (35) is formed by a metal mobile cylinder comprising solid parts (36) and pierced parts (37) for the at least partial protection of said at least one cryogenic condenser (31, 32, 33, 34) from high-frequency waves.

22. The device (1, 70) according to one of claims 1 to 21 characterized in that it comprises an enclosure able to recover the oxygen when the temperature of said at least one cryogenic condenser (11,31, 32, 33, 34, 81) to freeze the oxygen is high.

23. The device (1, 70) according to one of claims 1 to 22 characterized in that said means (13, 83) for recovering the hydrogen coming from the dissociation are placed outside of said magnetic mirror configuration.

24. The device (1, 70) according to one of claims 1 to 23 characterized in that said means (13, 83) to recover the hydrogen coming from the dissociation comprise a pump used to pump the hydrogen in gaseous phase.

25. The device (1, 70) according to one of claims 1 to 24 characterized in that said means (13, 83) to recover the hydrogen coming from the dissociation comprise at least one cryogenic condenser to freeze the hydrogen.

26. The device (1, 70) according to claim 25 characterized in that it comprises an enclosure able to recover the hydrogen when the temperature of said at least one cryogenic condenser to freeze the hydrogen is high.

27. The device (1, 70) according to one of claims 1 to 26 characterized in that said means for injecting (15, 85) a high-frequency wave inside said chamber (2, 72) comprise an entrance window placed in a high magnetic field so that the plasma diffuses towards the chamber (2, 72) and thus prevents the impact of plasma on said window.

28. The device (1, 70) according to one of claims 1 to 27 characterized in that said module of said magnetic field minimum is between 90% of said electron cyclotron resonance value and said electron cyclotron resonance value;

29. The device (1, 70) according to one of claims 1 to 28 characterized in that it comprises means for injecting multi-frequency high-frequency waves.
